(19) United States
(12) Patent Application Publication
(10) Pub. No.: US 2022/0098007 A1
(43) Pub. Date: Mar. 31, 2022

(54) DEVICE FOR CONTROLLING THE FUNCTION OF A VACUUM LIFTING DEVICE, AND VACUUM LIFTING DEVICE HAVING SUCH A CONTROL DEVICE

(71) Applicant: FIPA Holding GmbH, Ismaning (DE)

(72) Inventor: Christopher JOST, Moosinning (DE)

(21) Appl. No.: 17/429,897

(22) PCT Filed: Feb. 6, 2020
(86) PCT No.: PCT/EP2020/053015

§ 371 Date: Aug. 10, 2021

(30) Foreign Application Priority Data
Feb. 11, 2019 (DE) 10 2019 103 251.2

(51) Int. Cl. B66C 1/02

(52) U.S. Cl. CPC B66C 1/0256

(57) ABSTRACT

The invention relates to a device (1) for controlling the function of a vacuum lifting device, the device (1) having an in particular neck-shaped distributor block (2) with a first port (3) and a second port (4), a first flow duct (6) being formed in the distributor block (2) via which duct the first port (3) can be fluidically-connected to the second port (4) as required with the aid of a first valve means (12), a second flow duct (7) being formed in the distributor block (2) via which duct the first port (3) can be fluidically-connected to the external atmosphere (50) as required with the aid of a second valve means (13), and a third flow duct (8) being formed in the

The present invention relates in general particularly to vacuum technology-based gripping systems for the dynamic handling of objects. Specifically, the invention relates in particular to vacuum lifting devices as well as corresponding devices for controlling the function of vacuum lifting devices.

Lifting and holding objects (workpieces) by means of vacuum requires vacuum lifting devices. The lifting process is rendered possible by a variable-length suction hose, for example a spiral tube, which is sometimes also referred to as a “lifting tube.” A load handling device which is primarily vacuum-operated, although can also be mechanical, is attached to the end of the variable-length suction hose.

Upon a vacuum lifting device being placed on the workpiece to be moved, the air contained in the vacuum suction device and lifting tube is evacuated and the lifting tube contracts like an accordion such that the workpiece clings to the vacuum suction device and can ultimately be lifted. When the vacuum decreases, the load is then lowered again.

Depending on the application, the vacuum is either generated by a side channel blower, a vacuum pump or a multi-chamber eductor (Venturi nozzle). An operating element attached to the tube lifter's lower end is used to manually control the tube lifter. It enables the one-handed control of the suctioning, lifting, lowering and subsequent release of the load.

Such controllers for vacuum lifting devices are in principle generally known from the prior art. For example, a valve for a vacuum lifting device is known from printed publication DE 20 2005 016 147 U1 via which the lifting tube can be vented so that the suctioned object can be set down and released.

The present invention is based on the task of specifying a solution for a particularly ergonomic operation of a vacuum lifting device, whereby a compact design of the vacuum lifting device is in particular desired.

This task is solved by a control device according to independent claim 1 as well as by a vacuum lifting device according to accompanying independent claim 8, whereby advantageous further developments thereof are specified in the respective dependent claims.

Accordingly, the invention relates in particular to a device for controlling the function of a vacuum lifting device, wherein the device comprises an in particular nozzle-shaped distributor block having a first port and a second port, wherein a first flow duct is formed in the distributor block via which the first port can be fluidly connected to the second port when needed by way of a first valve means.

Further provided is for a second flow duct to be formed in the distributor block via which the first port can be fluidly connected to the external atmosphere when needed by way of a second valve means. Furthermore, the invention provides for a further third flow duct to be formed in the distributor block via which the second port can be fluidly connected to the external atmosphere when needed by way of a third valve means.

In other words, the present invention relates in particular to a compact and modular design for the control of a vacuum lifting device, wherein said control enables the actuating, initiating or respectively triggering of all the necessary functions of the vacuum lifting device. The invention is in particular characterized by the distributor block exhibiting a nozzle-shaped body, which allows a modular structure and which in turn also enables short control channels, such that the response characteristic and in particular the response time of the corresponding valve means of the distributor block are optimized.

The in particular nozzle-shaped and modular design of the distributor block further-more ensures an even distribution of weight, this proving to be an advantage with respect to the manual handling of the vacuum lifting device. In addition, the modular structure of the distributor block enables its use in various different vacuum lifting devices.

According to preferential implementations of the inventive solution, it is provided for at least some areas of the distributor block to exhibit an essentially tubular or nozzle-shaped body and be of at least substantially rotationally symmetric design.

The first port is thereby formed on a first end face and the second port is formed on an opposite second end face of the at least partly essentially tubular or nozzle-shaped body. The essentially tubular or nozzle-shaped body preferably has an outer diameter which corresponds at least substantially to the inner diameter of the variable-length suction hose of the vacuum lifting device. This thereby enables the entire distributor block to be integrated within the variable-length suction hose. This results in a particularly compact, low-maintenance and reliable vacuum lifting device as all the valve means are effectively protected from external influences (contamination, moisture, etc.).

The distributor block can comprise a first port region pointing radially from or protruding from the distributor block for the preferably detachable connection of the first valve means, a second port region pointing radially from or protruding from the distributor block for the preferably detachable connection of the second valve means, as well as a third port region pointing radially from or protruding from the distributor block for the preferably detachable connection of the third valve means. The respective port regions are thereby preferably evenly distributed on the outer surface of the distributor block in order to enable an even distribution of weight.

The first, second and third valve means each comprise at least one valve, in particular a throttle valve, whereby said at least one valve is preferably an electromotive valve with a valve drive or a valve operated electromagnetically.

The valve means can thereby be operated particularly precisely and without mechanical effort, which enables an ergonomic as well as fluid lifting and transferring of loads such as, for example, boxes, bags, wood and plastic sheets, sheet metal or glass panes in a wide variety of industries. The lifting and suctioning is thereby executed in a single step in the easiest possible way, resulting in a comfortable working rhythm.

According to one preferential implementation of the inventive control device, at least some areas of the first flow duct fluidly connecting the first port to the second port when needed run along the longitudinal axis of the distributor block, whereby the first flow duct flow can be interrupted when needed, and that by means of a dividing wall which preferably runs vertical or at least substantially vertical to the longitudinal axis of the distributor block as well as by means of the first valve means working in concert with said dividing wall. Thereby able to be provided in a state in which a fluid connection between the first and second port is cut off by way of the first valve means and interacting dividing wall is for the first flow duct to be divided into a first region and a second region separated therefrom.

According to further developments of the latter embodiment, it is provided for the second valve means to be designed to establish a fluid connection as needed between the first region and the external atmosphere, whereby the third valve means is designed to establish a fluid connection as needed between the second region and the external atmosphere.

The invention relates not only to a control device of the aforementioned type but also to a vacuum lifting device particularly having a nozzle-shaped distributor block of the aforementioned type.

According to implementations of the inventive solution, the vacuum lifting device comprises a suction line extending between a vacuum connection and an outlet opening. Although it is entirely feasible for the vacuum lifting device to comprise a mechanical load-handling means, it is preferential for a suction means, particularly in the form of a suction cup, to be used as the load-handling means, whereby said suction means serves the sealing engagement with the surfaces of transport items. The vacuum lifting device furthermore comprises a variable-length suction hose which limits the suction line at least in some areas between the suction means and the vacuum connection.

The load-handling means preferably employed as a suction means is preferably releasably attached to the suction line in an end region of the variable-length suction hose and delimits the outlet opening.

The in particular nozzle-shaped distributor block of the vacuum lifting device thereby serves particularly in the setting of a negative pressure in the suction hose to affect a free flow cross-section of the suction line within a section of line between the suction hose and the outlet opening and/or in the setting of a negative pressure in a section of line between the end region of the suction hose and the outlet opening.

It is advantageously provided for the distributor block to be fully accommodated in the suction hose at the end region of said suction hose. It thereby makes sense for the suction line to be partially formed by the first flow duct of the distributor block.

According to preferential implementations of the inventive vacuum lifting device, an operating device, particularly in the form of a pistol grip, is further provided between the suction means and the end region of the suction hose. It thereby makes sense for the suction means to be pivotably mounted to the operating device in preferably detachable or replaceable manner via a coupling.

Preferentially, the operating device exhibits suitable electrical switches or buttons such as membrane switches or membrane keys, for example, so as to be able to accordingly control the first, second and third valve means. Preferably, the electrical switches or buttons are each connected to the corresponding valve means via an electrical line, whereby the electrical lines are preferentially at least partially integrated or accommodated in the wall of the suction line.

Provided according to a further aspect of the present invention is for the electrical switches or buttons of the operating device to be remotely controllable, in particular via wireless remote control.

Alternatively or additionally, it is provided for the operating device to comprise at least one display or indicator for displaying information relevant to the operation of the vacuum lifting device such as for example the weight force of an object held by the vacuum lifting device, the height between the suction means and the floor, or the position and/or motion data of the vacuum lifting device.

According to a further aspect, the present invention relates to a system having a first vacuum lifting device of the aforementioned type and an optional crane system via which the vacuum lifting device can be positioned at different positions. It is thereby further provided for the system to comprise at least one further second vacuum lifting device, particularly a further second vacuum lifting device of the aforementioned type, whereby the first and at least one second vacuum lifting device are connected to one another via a data transmission channel for transmitting data.

In particular provided with the system according to the invention is for the first and at least one second vacuum lifting device to be designed to communicate and/or exchange data pursuant to the master/slave principle, wherein the first vacuum lifting device, for example, is designed to synchronize operation of the second vacuum lifting device to the operation of the first vacuum lifting device.

So as to be able to operate the aforementioned system according to the invention, the first vacuum lifting device can thus be preferably manually controlled by the operator of the system via the operating device of the first vacuum lifting device, and that by controlling the first, second and/or third valve means of the first vacuum lifting device. The at least one further second vacuum lifting device is thereby preferably controlled automatically, and even more preferentially selectively automatically, particularly in synchronization with the first vacuum lifting device.

The following will reference the accompanying drawings in describing the invention in greater detail on the basis of exemplary embodiments.

Shown are:

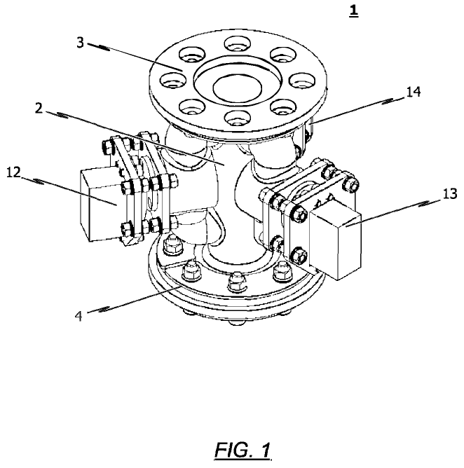

FIG. 1a schematic and isometric view of an exemplary embodiment of the control device according to the invention;

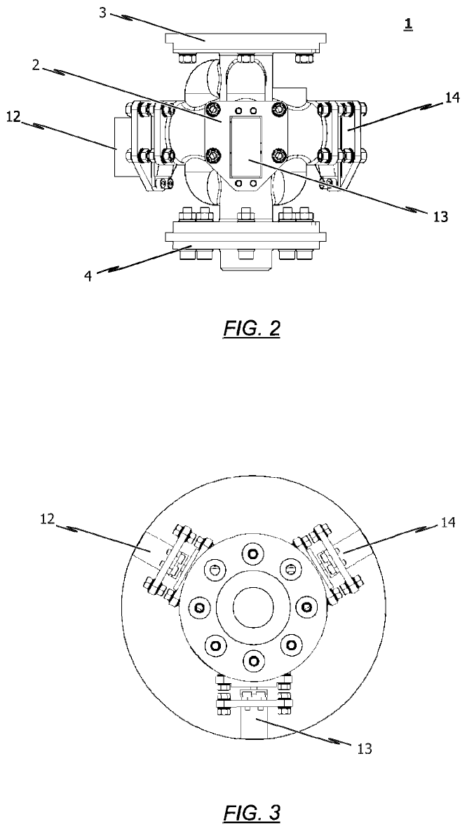

FIG. 2a schematic and side view of the control device according to FIG. 1;

FIG. 3a schematic and top view of the control device according to FIG. 1;

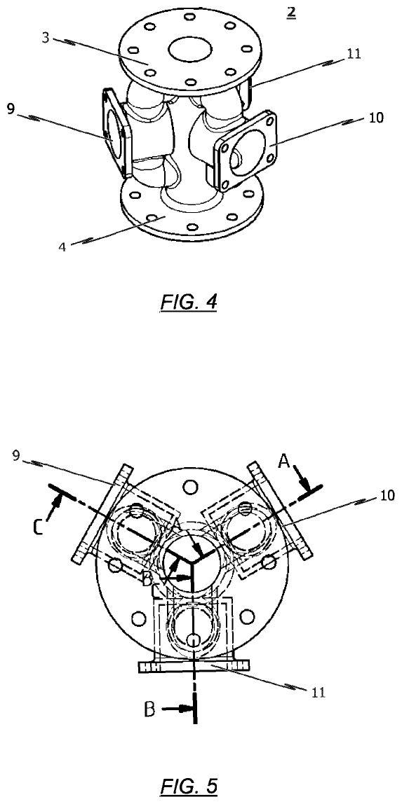

FIG. 4a schematic and isometric view of the distributor block of the control device according to FIG. 1;

FIG. 5a schematic sectional top view of the distributor block according to FIG. 1;

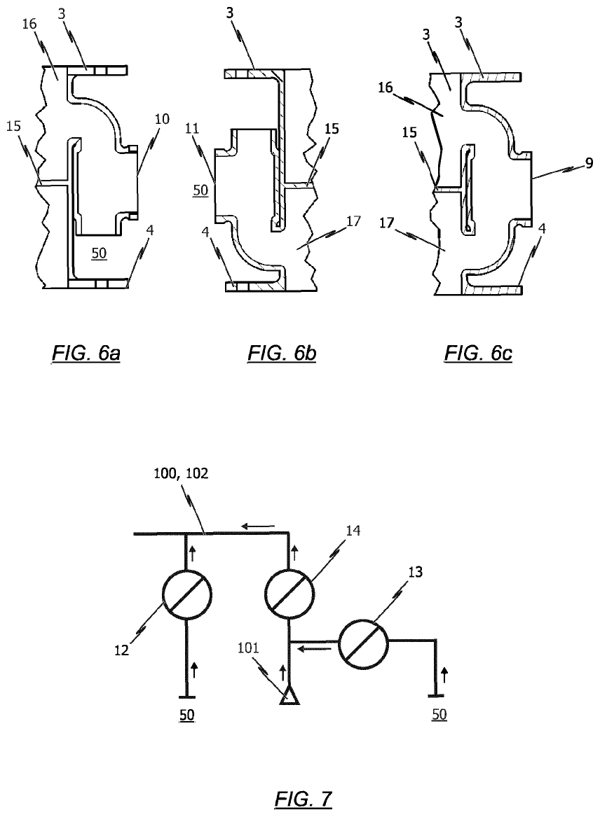

FIG. 6a a schematic sectional view along the A-A line in FIG. 5;

FIG. 6b a schematic sectional view along the B-B line in FIG. 5;

FIG. 6c a schematic sectional view along the C-C line in FIG. 5; and

FIG. 7a schematic pneumatic diagram of the inventive control device.

The exemplary embodiment of the control device 1 according to the invention depicted in the drawings serves to control the function of a vacuum lifting device.

Such a vacuum lifting device comprises a suction line 102 extending between a vacuum connection and an outlet opening. The vacuum lifting device furthermore comprises a load-handling means which primarily works with vacuum and can be realized as a suction means, particularly in the form of a suction cup, although other mechanical load-handling means are in principle also conceivable. The load-handling means in particular realized as suction means 101 serves the sealing engagement with the surfaces of transport items.

The vacuum lifting device further comprises a variable-length suction hose 100 which at least partially delimits the suction line 102 between the load-handling means 101 particularly realized as suction means 101 and the vacuum connection.

The load-handling means 101 in particular realized as suction means is thereby preferably releasably attached to the suction line 102 at an end region of the variable-length suction hose 100 and delimits the outlet opening, particularly when the load-handling means 101 is realized as a suction means.

To set a negative pressure in the suction hose 100 to affect a free flow cross-section of the suction line 102 in a line section between the suction hose 100 and the outlet opening and/or to set a negative pressure in a line section between the end region of the suction hose 100 and the outlet opening, the inventive control device 1 makes use of an in particular nozzle-shaped distributor block 2.

As can be seen particularly in FIGS. 1 to 3, the distributor block 2 is in particular designed in the form of a nozzle and comprises a first port 3 as well as a second port 4. A first flow duct 6 is formed in the distributor block 2 via which the first port 3 can be fluidly connected to the second port 4 when needed by way of a first valve means 12. A second flow duct 7 is further formed in the distributor block 2 via which the first port 3 can be fluidly connected to the external atmosphere 50 when needed by way of a second valve means 13. A third flow duct 8 is more-over formed in the distributor block 2 via which the second port 4 can be fluidly connected to the external atmosphere 50 when needed by way of a third valve means 14.

As can be seen particularly from the isometric view according to FIG. 1, at least some areas of the distributor block 2 exhibit an essentially tubular or nozzle-shaped body and said block is of at least substantially rotationally symmetric design. The first port 3 is thereby formed on a first end face and the second port 4 is formed on an opposite second end face of the essentially tubular or nozzle-shaped body.

In the exemplary embodiment according to FIG. 4, the distributor block 2 comprises a first port region 9 pointing radially from or protruding from the distributor block 2 for the preferably detachable connection of the first valve means 12, a second port region 10 pointing radially from or protruding from the distributor block 2 for the preferably detachable connection of the second valve means 13, a third port region 11 pointing radially from or protruding from the distributor block 2 for the preferably detachable connection of the third valve means 14.

The first, second and third valve means 12, 13, 14 each comprise at least one valve, in particular a throttle valve, whereby said at least one valve is preferably an electromotive valve with a valve drive or a valve operated electromagnetically.

In the exemplary embodiment of control device 1, at least some areas of the first flow duct 6 fluidly connecting the first port 3 to the second port 4 when needed run along the longitudinal axis of the distributor block 2. This first flow duct 6 flow can be interrupted when needed, and that by means of a dividing wall 15 which preferably runs vertical or at least substantially vertical to the longitudinal axis of the distributor block 2 as well as by means of the first valve means 12 working in concert with the dividing wall 15. In a state in which a fluid connection between the first and second port 3, 4 is cut off by way of the first valve means 12 and interacting dividing wall 15, the first flow duct 6 is thereby divided into a first region 16 and a second separate region 17.

The exemplary embodiment further provides for the second valve means 13 to be designed to establish a fluid connection as needed between the first region 16 and the external atmosphere 50, whereby the third valve means 14 is designed to establish a fluid connection as needed between the second region 17 and the external atmosphere 50.

The distributor block 2 is advantageously realized as a monolithic component, and in particular made of metal or preferentially plastic.

The distributor block 2 is preferably fully accommodated in the suction hose 100 at the end region of said suction hose 100 of the vacuum lifting device, wherein the suction line 102 of the vacuum lifting device is partially formed by the first flow duct of the distributor block 2. The distributor block 2 with valve means 12, 13, 14 thereby serves in the setting of a negative pressure in the suction hose 100, the setting of a free flow cross-section of the suction line 102 within a section of line between the suction hose 100 and the outlet opening of the suction means and/or the setting of a negative pressure in a section of line between the end region of the suction hose 100 and the outlet opening.

The inventive vacuum lifting device, which as such is not depicted in the drawings, preferably comprises an operating device, particularly in the form of a pistol grip, between the suction means 101 and the end region of the suction hose 100, whereby the suction means 101 is pivotably mounted to the operating device, particularly in detachable or replaceable manner, preferably via a coupling.

The operating device exhibits suitable electrical switches or buttons, in particular membrane switches or membrane keys, so as to be able to control the first, second and third valve means. The electrical switches or buttons are each connected to the corresponding valve means via an electrical line, whereby the electrical lines are preferably at least partially integrated or accommodated in the wall of the suction line 102.

According to a further aspect of the invention, the electrical switches or buttons of the operating device are remotely controllable, in particular partly remotely controllable, for example via wireless remote control.

It can further be provided for the operating device to comprise at least one display or indicator for displaying information relevant to the operation of the vacuum lifting device to the user.

The invention is not limited to the embodiment depicted in the drawings as an example but rather yields from an integrated overall consideration of all the features disclosed herein.

1. A device, comprising:
a nozzle-shaped distributor block having
a first port;
a second port;
wherein a first flow duct,
wherein the first port is fluidly connected to the second port, via the first flow duct, via a first valve means,
a second flow duct;
wherein the first port is fluidly connected to an external atmosphere via a second valve means; and
a third flow duct;
wherein the second port is fluidly connected to the external atmosphere via a third valve means; and
wherein the device is configured to control a function of a vacuum lifting device.

2. The device according to claim 1,
wherein at least one area of the nozzle-shaped distributor block comprises a tubular or nozzle-shaped body; and
wherein the at least one area of the nozzle-shaped distributor block comprises a rotationally symmetric design,
wherein the first port is formed on a first end face; and
wherein the second port is formed on an opposite second end face of the at least one area of the nozzle-shaped distributor block.

3. The device according to claim 1,
wherein the nozzle-shaped distributor block comprises a first port region pointing radially from or protruding from the nozzle-shaped distributor blocks;
wherein the first port region is detachably connected to the first valve means,
wherein the nozzle-shaped distributor block comprises a second port region pointing radially from or protruding from the nozzle-shaped distributor block;
wherein the second port region is detachably connected to of the second valve means, and
wherein the nozzle-shaped distributor block comprises a third port region pointing radially from or protruding from the nozzle-shaped distributor block;
wherein the third port region is detachably connected to the third valve means.

4. The device according to claim 1,
wherein the first valve means, the second valve means and the third valve means each comprise at least one throttle valve,
wherein said at least one throttle valve is preferably an electromotive valve with a valve drive or a valve operated electromagnetically.

5. The device according to claim 1,
wherein at least a portion of the first flow duct fluidly connecting the first port to the second port runs along a longitudinal axis of the nozzle-shaped distributor block and can be fluidly interrupted when needed by means of a dividing wall and the first valve means;
wherein the dividing wall runs substantially vertical to the longitudinal axis of the nozzle-shaped distributor block,
wherein in a configuration in which the first valve means and the dividing wall cut off a fluid connection between the first port and the second port, the first flow duct is divided into a first region and a second region;
wherein the second region is separate from the first region.

6. The device according to claim 5,
wherein the second valve means is configured to establish a fluid connection between the first region and the external atmosphere, and
wherein the third valve means is configured to establish a fluid connection between the second region and the external atmosphere.

7. The device according to claim 1,
wherein the nozzle-shaped distributor block is a monolithic component comprising metal or plastic.

8. A vacuum lifting device comprising:
a suction line extending between a vacuum connection and an outlet opening;
a suction means,
wherein the suction means is configured to provide a sealing engagement with at least one surface of at least one transport item; and
a variable-length suction hose configured to limit at least a portion of the suction line between the suction means and the vacuum connection,
wherein the suction means is releasably attached to the suction line in an end region of the variable-length suction hose and delimits an outlet opening; and
a device comprising a nozzle-shaped distributor block according to claim 1;
wherein the nozzle-shaped distributor block is configured to at least one of:
i) set a negative pressure in the variable-length suction hose to affect a free flow cross-section of the suction line within a first section of line between the variable-length suction hose and the outlet opening; or
ii) set a negative pressure in a second section of the suction line between the end region of the variable-length suction hose and the outlet opening.

9. The vacuum lifting device according to claim 8,
wherein the nozzle-shaped distributor block is fully accommodated in the variable-length suction hose at the end region of said variable-length suction hose, and wherein the suction line is partially formed by the first flow duct of the nozzle-shaped distributor block.

10. The vacuum lifting device according to claim 8,
wherein an operating device, is further provided between the suction means and the end region of the variable-length suction hose,
wherein the suction means is pivotably mounted to the operating device in a detachable or replaceable manner via a coupling.

11. The vacuum lifting device according to claim 10,
wherein the operating device comprises at least one electrical switch or button configured to control the first valve means, the second valve means and the third valve means, wherein the at least one electrical switch or button is connected to a corresponding valve means via an electrical line, and
wherein the electrical line is at least partially integrated or accommodated in a wall of the suction line.

12. The vacuum lifting device according to claim 11,
wherein the at least one electrical switch or button is configured to be controllable.

13. The vacuum lifting device according to claim 10,
wherein the operating device comprises at least one display configured to display information relevant to an operation of the vacuum lifting device.

14. A system comprising:
a first vacuum lifting device according to claim 8;
an optional crane system via which the vacuum lifting device can be positioned at different positions,
a second vacuum lifting device according to claim 8,
wherein the first vacuum lifting device and the second vacuum lifting device are connected to one another via a data transmission channel,
wherein the data transmission channel is configured to transmit data.

15. The system according to claim 14,
wherein the first vacuum lifting device and the second vacuum lifting device are configured to communicate and exchange data with one another,
wherein the first vacuum lifting device is configured to synchronize an operation of the second vacuum lifting device to an operation of the first vacuum lifting device.

16. A method comprising:
manually controlling the first vacuum lifting device via the operating device of the first vacuum lifting device by controlling at least one of the first valve means, the second valve means, or the third valve means of the first vacuum lifting device, and
automatically controlling the second vacuum lifting device in synchronization with the first vacuum lifting device;
wherein the method is for operating a system according to claim 14.
